(19) United States
(12) Patent Application Publication
(10) Pub. No.: US 2006/0147758 A1
(43) Pub. Date: Jul. 6, 2006

(54) Perpendicular magnetic recording medium with magnetically resetable single domain soft magnetic underlayer

(76) Inventors: Hong-Sik Jung, Cupertino, CA (US); Michael Raymond Avenell, San Jose, CA (US)

Correspondence Address: Daniel E. Ovanezian;BLAKELY, SOKOLOFF, TAYLOR & ZAFMAN LLP, Seventh Floor, 12400 Wilshire Boulevard, Los Angeles, CA, 90025, US

(21) Appl. No.: 11/031,613

(22) Filed: Jan. 6, 2005

(51) Int. Cl. G11B 5/66

(52) U.S. Cl. 428/828.1; 428/829

(57) ABSTRACT

A perpendicular magnetic recording disk with a magnetically resetable single domain soft magnetic underlayer. The perpendicular magnetic recording disk may include a hard magnetic pinning layer disposed above a substrate, a spacer layer disposed above the hard magnetic pinning layer, a soft ferromagnetic film disposed above the spacer layer, and a magnetic recording layer disposed above the soft ferromagnetic film.

### TECHNICAL FIELD

This invention relates to the field of disk drives and more specifically, to perpendicular magnetic recording disks used in disk drives.

### BACKGROUND

Perpendicular magnetic recording systems have been developed to achieve higher recording density than may be possible with longitudinal magnetic recording systems. FIG. 1A illustrates portions of a conventional perpendicular magnetic recording disk drive system. The disk drive system has a recording head that includes a trailing write pole, a leading return (opposing pole) magnetically coupled to the write pole, and an electrically conductive magnetizing coil surrounding the yoke of the write pole. The bottom of the opposing pole has a surface area greatly exceeding the surface area of the tip of the write pole. To write to the magnetic recording disk, the recording head is separated from the magnetic recording disk by a distance known as the flying height. The magnetic recording disk is rotated past the recording head so that the recording head follows the tracks of the magnetic recording media. Current is passed through the coil to create magnetic flux within the write pole. The magnetic flux passes from the write pole, through the disk, and across to the opposing pole. Conventional perpendicular recording disks typically include a magnetic recording layer in which data are recorded, and a soft magnetic underlayer (SUL). The SUL enables the magnetic flux from the trailing write pole to return to the leading opposing pole of the head with low impedance, as illustrated by the head image of FIG. 1A. A relatively thick SUL, for example, approximately 40-200 nanometers (nm) is needed to facilitate magnetic flux return to the leading opposing pole of the head with low impedance. SULs that are too thin or have too low magnetization show saturated regions on the bottom of SUL where significant amounts of magnetic charge are formed, which result in magnetic flux leakage and poor SUL performance. Further increase in SUL thickness greater than 200 nm leads to better magnetic flux containment but spatial oscillations of magnetization inside the SUL can induce magnetostatically driven vortex structures corresponding to SUL-induced write noise, as discussed in Manfred E. Schabes et al., Micromagnetic Modeling of Soft Underlayer Magnetization Processes and Fields in Perpendicular Magnetic Recording, IEEE Transactions on Magnetics, Vol. 38, No. 4, 1670, July 2002. The SUL thickness also depends on the type of write heads. To use of shielded pole write heads as proposed in M. Mallary et al., One Terabit per Square Inch Perpendicular Recording Concept Design, IEEE Transactions on Magnetics, Vol. 38, No. 4, 1719, July 2002, can reduce the SUL thickness requirement up to 50% compared to an unshielded pole design.

Perpendicular recording disks should have much narrower PW₅₀ than is currently observed in longitudinal recording disks because in a perpendicular recording layer all of the magnetic easy axes are aligned in the perpendicular direction, i.e. the direction of recording. With this perpendicular recording type of media, the SUL is intended to serve as a flux concentrator to provide a sharp head field gradient so that narrow transitions can be written. The SUL, however, contains magnetic structures that are fully exchange coupled and, as such, any magnetization transition present in the SUL will be at least as broad as a typical domain wall width (e.g., 100 to 500 nm), illustrated in FIG. 1B. Such a domain wall provides stray fields much stronger than the fields from the recording layer, which causes typically spike noise. Reversed magnetic domains are usually observed due to the strong demagnetization fields along the edges of a disk.

A SUL with a high permeability is desirable because it enhances head field strength and gradient during the writing process. However, a SUL with too high permeability can cause saturation of the read head elements, exhibits a high sensitivity to stray fields higher than the coercivity (H_{c}) of the SUL, and increases wide area adjacent track erasure as well as magnetic domain noise. The induced anisotropy field (Hₖ) of the soft, ferromagnetic (FM) layer in most SULs can be lost at an elevated temperature under stray fields. This may result in reduced permeability along the circumferential direction and cause poor SUL performance with jittery time response to a drive write field, as discussed in Dimitri Litvinov et al., Recording Layer Influence on the Dynamics of a Soft Underlayer, IEEE Transactions on Magnetics, Vol. 38, No. 5, 1994, September 2002. Thus, thermal stability requires that Hₖ does not vanish at a maximum disk operation temperature of approximately 100° C. Simulation results showed that the sensitivity to stray fields was greatly reduced with little effect on recording performance if the permeability of the SUL was reduced to 100, as discussed in H. Muraoka et al., Low Inductance and High Efficiency Single-Pole Writing Head for Perpendicular Double Layer Recording Media, IEEE Transactions on Magnetics, Vol. 35, No. 2, 643, March 1999. The production of a low noise SUL while maintaining a single domain state, medium permeability along the circumferential direction, magnetic stability from stray fields and thermal stability has been a difficult goal to achieve due to the high cost and complex manufacturability of current solutions.

One solution has involved the use of a triple layer structure having a Cobalt Samarium (CoSm) hard magnetic pinning layer, as discussed in U.S. Pat. No. 6,548,194 and Toshio Ando et al., Triple-Layer Perpendicular Recording Media for High SN Ration and Signal Stability, IEEE Transactions on Magnetics, Vol. 38, No. 5, 2983, September 1997. The triple layer structure includes a CoCrTa perpendicular recording layer, a CoZrNb soft magnetic layer, and a CoSm layer that pins the magnetic domains in the SUL and provides a single domain state. This single domain situation was only maintained, however, when the effect of the CoSm pinning layer on exchange coupling was dominant. It required a relatively thick CoSm thickness of 150 nm. Furthermore, reversed edge magnetic domains of CoSm/CoZrNb were still present due to strong demagnetization fields along the edges of the disk, which was caused by ferromagnetic configurations in CoSm/CoZrNb exchange coupled films. If a thin hard magnetic (HM) layer is used, the HM/FM bilayer will show typical uniaxial switching characteristics with a relatively high coercivity for a soft FM layer due to strong ferromagnetic coupling with the HM layer. This, in turn, will result in a loss of single remanent magnetization state and loss of the exchange bias field (H_{eb}), i.e., a shift of the hysteresis loop in a minor hysteresis loop measurement. Magnetic orientation of the SUL depends entirely on the magnetic orientation of the HM used.

Another solution to reducing spike noise that originates from domain walls in the SUL in the presence of stray fields in the disk drive is through the use of an antiferromagnet (AF) pinning layer either between the SUL and the substrate or in an [AF/FM]ₙ multilayer structure. Either a structurally disordered AF of Iron Manganese (FeMn) and Iridium Manganese (IrMn) or a structurally ordered AF of Platinum Magnesium (PtMn), Palladium Platinum Magnesium (PdPtMn), and Nickel Manganese (NiMn) can be used as an AF pinning layer. Unidirectional uncompensated interfacial magnetic moments of the AF are induced along the magnetization direction of the SUL during film deposition or via a post annealing process, as discussed, for example, in U.S. Pat. No. 6,723,457, S. Tanahashi et al., A Design of Soft Magnetic Backlayer for Double-layered Perpendicular Magnetic Recording Medium, Journal of Magnetic Society in Japan, Vol. 23 No. S2, 1999, and Jung et al., FeTaN/IrMn Exchange-Coupled Multilayer Films as Soft Underlayers for Perpendicular Media, IEEE Transactions on Magnetics, Vol. 37, No. 4, 2294, July 2001. An ordered AF having better thermal stability than a disordered AF requires an annealing process, at 250-280° C. for 2-5 hours with an orienting field of >1 kOe, to achieve a face-centered tetragonal AF phase. Thus, a disordered AF is preferred in order to get H_{eb} without additional annealing. Since H_{eb}∝1/t_{FM} where t_{FM} is the thickness of soft FM layer, the hysteresis loop can be shifted by decreasing t_{FM} until H_{eb}>H_{c}. This results in a unique single remanent state to which the system returns after any field cycle. The magnetization perpendicular to the pinned direction is highly reversible, a key requirement for prevention of domain wall formation. With such a solution, the single domain state of the SUL is achieved by an exchange coupling with the AF pinning layer and is independent on stray fields. FeMn has poor corrosion resistance and low blocking temperature (T_{B}) of 150° C., where T_{B} is the temperature at which H_{eb} becomes zero. However, IrMn exhibits sufficient corrosion resistance and T_{B} and, thus, can be used in recording media, as discussed in S. Takenoiri et al., Exchange-Coupled IrMn/CoZrNb Soft Underlayers for Perpendicular Recoding Media, IEEE Transactions on Magnetics, Vol. 38, No. 5, 1991, September 2002. However, IrMn is so expensive that it can significantly increase manufacturing cost. Another problem associated with using IrMn is that it still requires an additional field annealing process to induce a uniform H_{eb} along the radial direction. Furthermore, demagnetizing fields that are relatively weaker than that in HM/FM layer structures still exist along the edges of the disk. Therefore, there is a possibility of forming reversed domains along the edges of a disk.

Another approach has involved the use of synthetic antiferromagnetic (SAF) coupled film structures. SAF coupled film structures originally developed for use in magnetic read sensors and longitudinal recording media are being used in perpendicular recording media to reduce edge demagnetization fields, improve robustness to stray fields, and enhance thermal stability. The SAF structures utilize a Ruthenium (Ru) spacer layer between two soft FM exchanged coupled layers, for example, composed of Cobalt Tantalum Zirconium (CoTaZr) or Iron Cobalt (FeCo). The Ru interlayer induces SAF coupling between the soft FM layers. In order to achieve an easy magnetization, a radial field of sufficiently high strength and uniformity distributed along the radial direction is necessary during film deposition. A SAF structure with equal soft FM layer thickness, however, may not hold a single domain state because of the same switching priority after removal of magnetic fields. A SAF structure with non-equal soft FM layer thickness aids magnetic alignment while maintaining a single domain state and increases H_{eb} in the top soft FM layer closest to the magnetic recording layer resulting in reduction of adjacent track erasure, as discussed in B. R. Acharya et al., Anti-Parallel Coupled Soft Underlayers for High-Density Perpendicular Recording, IEEE Transactions on Magnetics, Vol. 40, No. 4, 2383, July 2004. However, undesired magnetic domain walls are easily induced because of a low H_{c} in a thicker bottom soft FM layer. A SAF structure with a thinner top layer requires a pinning layer for the thicker, bottom soft FM layer, as discussed below.

The general pinning concept was originally developed for use in spin valve heads. A typical spin valve head consists of an AF layer coupled to the FM pinned layer, a spacer layer, and a soft free FM layer. The most common AF materials used are PtMn, PdPtMn, and IrMn. As previously discussed, these materials are expensive and generally more susceptible to corrosion. In order to replace such expensive AF layer materials with an inexpensive permanent magnet, a structure having a permanent magnet, spacer layer, and FM pinned layer was developed, for example, as discussed in U.S. Pat. No. 6,754,054, Michael A. Seigler et al., Use Of A Permanent Magnet In The Synthetic Antiferromagnetic Of A Spin-Valve, Journal of Applied Physics, vol. 91, No. 4, 2176, February 2002, and Yihong Wu et al., Antiferromagnetically Coupled Hard/Ru/Soft Layers and Their Applications In Spin Valves, Applied Physics Letters, vol. 80, No. 23, 4413, June 2002. Such references discuss the use of CoCrPt as the HM layer, Ru as the spacer layer, and CoFe or NiFe as the soft magnetic pinned layer. In particular, Wu et al. discusses a series of experiments that were carried out to study the dependence of H_{eb} on the thickness of the CoFe and NiFe layers. It was reported that such structures exhibited a higher H_{eb} and better thermal stability than IrMn or PtMn pinning layer structures. FIG. 1C illustrates the magnetization M (memu/cm²) versus the field H (kOe) loops of a structure of Cr(4)/CoCrPt(8)/Ru(0.8)/CoFe(t) with the thickness t=2, 3.5, and 6 nm, respectively. The results of the experiments illustrated in FIG. 1C show that the magnetic exchange coupling of the CoCrPt/Ru/CoFe (HM pinning layer/space layer/soft FM pinned layer) structure changed from antiferromagnetic to ferromagnetic coupling as the CoFe pinned layer thickness was increased from 2 to 6 nm. The SAF coupling was only observed, however, when the CoFe pinned layer was less than 6 nm thick. A less than 6 nm thickness layer would not be suitable for use in a SUL for perpendicular magnetic recording disks that typically require a thickness in the range of 40-200 nm. The lose of SAF coupling strength at 6 nm is not surprising because it was reported that the J_{AF} very rapidly decreased above 5 nm thickness, as discussed in S. C. Byeon et al., Synthetic Antiferromagnetic Soft Underlayers for perpendicular Recording Media, IEEE Transactions on Magnetics, Vol. 40, No. 4, 2386, July 2004, and it also exhibited a large H_{c} of 120 Oe in 6 nm-thick CoFe. Both a reduction of J_{AF} and an increase in H_{c} will contribute to ferromagnetic configuration. In order to enhance H_{eb}, a thin (0.5-2 nm) CoFe film was inserted between the CoCrPt pinning layer and the spacer Ru layer resulting in a CoCrPt/CoFe/Ru/CoFe structure. This decreased the H_{c} of the CoCrPt/CoFe layer stack, which was found to be deleterious for read sensor applications.

### BRIEF DESCRIPTION OF THE DRAWINGS

The present invention is illustrated by way of example and not limitation in the figures of the accompanying drawings, in which like references indicate similar elements and in which:

FIG. 1A illustrates a conventional perpendicular recording disk drive system.

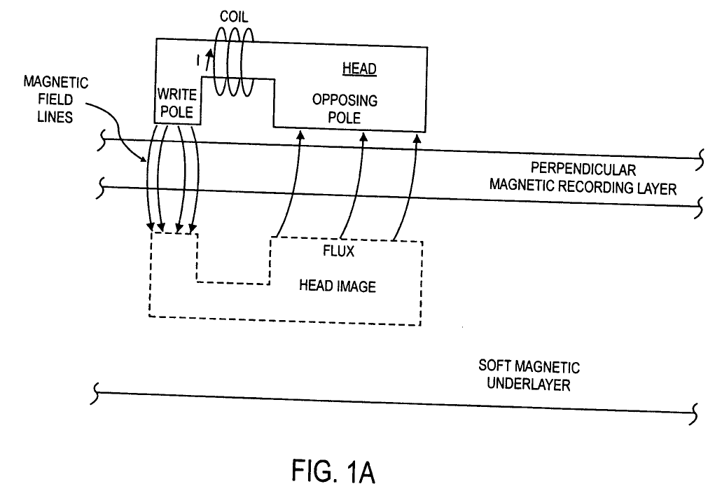

FIG. 1B illustrates domain wall effects in a conventional perpendicular recording disk drive system.

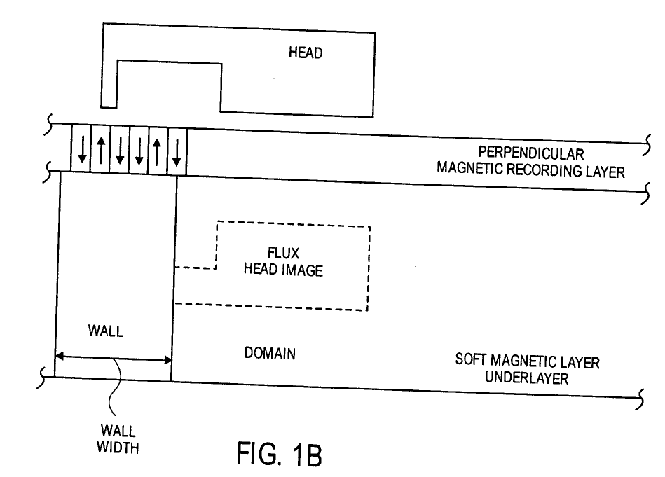

FIG. 1C illustrates M-H loops of the pinned layer in a prior art spin valve structure.

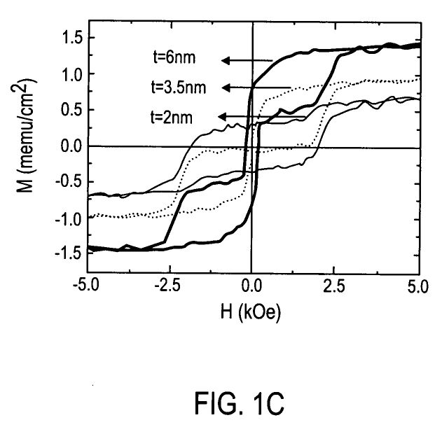

FIG. 2 illustrates one embodiment of a perpendicular magnetic recording disk having a HM pinning layer and a soft FM pinned film.

FIG. 3A illustrates the expected full and minor M-H loops of the SUL for a perpendicular magnetic recording disk having a HM pinning layer and a soft FM pinned film.

FIG. 3B illustrates the measured M-H loops of the SUL for a perpendicular magnetic recording disk with particular layer materials and thickness, according to one embodiment of the present invention.

FIG. 3C illustrates optical surface analyzer Kerr images of different types of SUL on perpendicular magnetic recording disks.

FIG. 3D illustrates minor M-H loops for the pinned direction of the pinned layer switched by an external magnetic field, according to one embodiment of the present invention.

FIG. 4A illustrates one embodiment of a perpendicular magnetic recording disk having an exchange coupling enhancing layer and a HM pinning layer.

FIG. 4B illustrates an alternative embodiment of a perpendicular magnetic recording disk having an exchange coupling enhancing layer and HM pinning layer.

FIG. 5 illustrates one embodiment of a perpendicular magnetic recording disk having a SAF pinned structured.

FIG. 6 illustrates an exemplary embodiment a perpendicular magnetic recording disk having a SAF pinned structured, exchange coupling enhancing layers, and a HM pinning layer.

FIG. 7 illustrates one embodiment of a method of manufacturing perpendicular magnetic recording disk.

FIG. 8 illustrates a disk drive having an embodiment of the perpendicular magnetic recording disk.

### DETAILED DESCRIPTION

In the following description, numerous specific details are set forth such as examples of specific materials, components, dimensions, etc. in order to provide a thorough understanding of embodiments of the present invention. It will be apparent, however, to one skilled in the art that these specific details need not be employed to practice embodiments of the present invention. In other instances, well-known components or methods have not been described in detail in order to avoid unnecessarily obscuring embodiments of the present invention.

The terms “above,” “below,” and “between” as used herein refer to a relative position of one layer with respect to other layers. As such, one layer deposited or disposed above or below another layer may be directly in con tact with the other layer or may have one or more intervening layers. Moreover, one layer deposited or disposed between layers may be directly in contact with the layers or may have one or more intervening layers. Further the term “underlayer” is used herein to refer to a position relative to the magnetic recording layer. As such, there may be one or more other layer(s) disposed between the underlayer and the magnetic recording layer. In addition, the term “film” as used herein may refer to one or more layers of material.

“Hard” or “soft” media can make up the layers in a perpendicular magnetic recording disk. A hard magnetic recording layer, acting as the data layer, may have large coercivity (e.g., approximately >3 kOe) along the out-of-plane direction with low exchange coupling between grains. A soft magnetic layer, on the other hand, may have relatively low coercivity, for example, approximately less than <30 Oe along the easy axis and approximately less <5 Oe along the hard axis. A hard magnetic (HM) pinning layer for a SUL may have coercivity in approximately a range of >50 Oe to less than 7 kOe along the in-plane direction with high exchange coupling between grains. Materials providing a soft magnetic layer may be used in conjunction with a hard magnetic layer to achieve improved performance as discussed below.

A perpendicular magnetic recording disk with a magnetically resetable single domain soft magnetic underlayer is described. The perpendicular magnetic recording disk may be used in a disk drive system that typically includes a read-write head. The head includes a trailing write pole, a leading return (opposing pole) magnetically coupled to the write pole. The SUL that resides underneath the hard magnetic recording layer is used in order to form a magnetic circuit with the head. The SUL provides a path for magnetic flux that flows to or from the head. The SUL with a HM-biased synthetic antiferromagnetically or ferrimagnetically coupled soft FM pinned film for a perpendicular magnetic recording disk may be composed of the following layers: a substrate; seed layer (e.g., comprising Cr); a HM pinning layer (e.g., comprising a Co based alloy); an antiferromagnetic coupling inducing (AI), spacer layer (e.g., comprising Ru); and a soft FM pinned film. In one embodiment, the HM pinning layer may include either a HM single layer or HM/thin soft FM bilayer. An in-plane isotropic or anisotropic HM layer can be used, but out-of-plane magnetization in the HM layer should be minimized in one embodiment.

In one embodiment, the soft FM pinned layer may include either a soft FM single layer or a SAF-coupled FM/AI/FM layer structure. A radial anisotropy field of the SUL is induced in any direction by exposing the SUL to external radial fields greater than the H, of the HM pinning layer(s) at room temperature. As long as longitudinal fields do not exceed the coercivity of the HM pinning layer, the soft FM pinned layer will return to a remanent state that is antiparallel to the HM pinning layer. This structure allows the pinned layer to easily be arranged into a single domain state with controllable magnetic orientation. By aligning the HM pinning layer in a uniform radial direction, the pinned layer can be pinned as a single domain in the radial direction while maintaining medium permeability, for example, in approximately a range of 30-400 in the circumferential direction of the SUL. In addition, the magnetically set SUL discussed herein may have improved stability to stray fields and improved thermal stability when compared to unpinned SULs and SAF coupled SULs. A significant advantage of such a structure is that conventional sputter equipment can be used for producing the described perpendicular recording media without any special modification.

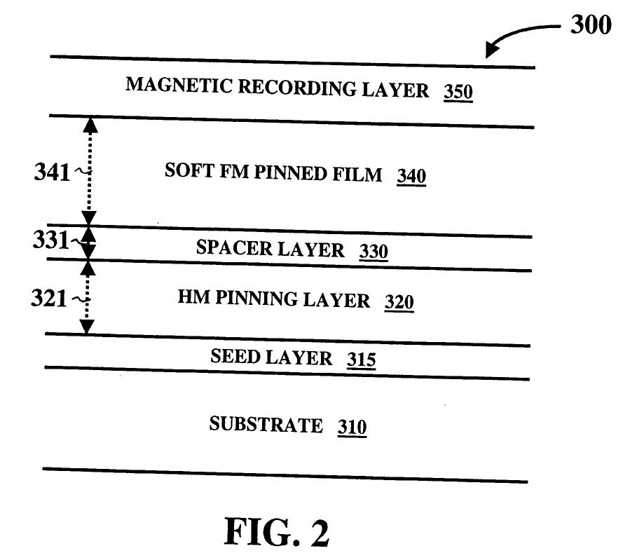

FIG. 2 illustrates one embodiment of a perpendicular magnetic recording disk. In one embodiment, perpendicular magnetic recording disk 300 includes a substrate 310, a hard magnetic recording layer 350, and an underlayer structure disposed there between. The above-mentioned layers (and the other layers discussed herein) may be formed on both sides of substrate 310 to form a double-sided magnetic recording disk. However, only the layers on a single side of substrate 310 are shown for ease of illustration. Alternatively, a single sided perpendicular magnetic recording disk may be formed.

A substrate 310 may be composed of, for example, a glass material, a metal, and a metal alloy material. Glass substrates that may be used include, for example, a silica containing glass such as borosilicate glass and aluminosilicate glass. Metal and metal alloy substrates that may be used include, for example, aluminum (Al) and aluminum magnesium (AlMg) substrates, respectively. In an alternative embodiment, other substrate materials such as polymers and ceramics may be used. Substrate 310 may also be plated with a nickel phosphorous (NiP) layer (not shown). The substrate surface (or the plated NiP surface) may be polished and/or textured. A seed layer 315 (e.g., Cr) may be disposed above substrate 310. Substrates and seed layers are known in the art; accordingly, a more detailed discussion is not provided.

In one embodiment, a HM pinning layer 320 is deposited above a seed layer 315. The HM pinning layer 320 may be composed of any hard magnetic material or any HM/FM bilayer, in one particular embodiment, having H_{c} in approximately a range of 100 to 2000 Oe and squareness ratio of magnetization greater than 0.60. The HM pinning layer 320 may have a thickness (t) 321 in approximately a range of 5 to 100 nm. In one embodiment, the HM pinning layer 320 may be composed of a Co based alloy or a Co based alloy/a CoFe alloy. Alternatively, the HM pinning layer 320 may have other coercivity, thickness, and materials. The HM pinning layer 320 is discussed in more detail below.

A spacer layer 330 is disposed above the HM pinning layer 320. The spacer layer 330 may be composed of a material such as Ru. Alternatively, other materials that induce SAF coupling between pinning layer 320 and pinned film 340 may be used for the spacer layer 330, for example, Rhodium (Rh), Iridium (Ir), or Chromium (Cr). The spacer layer 330 may have a thickness 331 in the range of approximately 0.4 to 1.0 nm and, in one particular embodiment, approximately 0.8 nm for Ru. Alternatively, the spacer layer 330 may have a thickness 331 outside of the range given above.

A soft FM pinned film 340 is disposed above the spacer layer 330. The soft FM pinned film 340 may be composed of any soft FM material with a saturation flux density 4πMₛ higher than, for example, 5 kG, or of any SAF-coupled FM/AI/FM layer structure and have a total FM layer thickness in approximately a range of 40-200 nm.

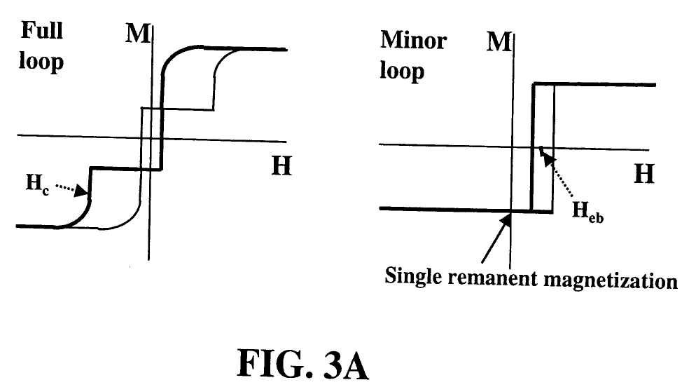

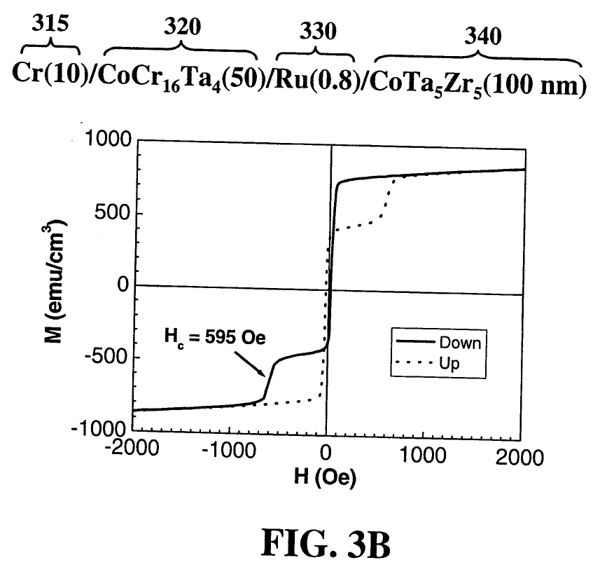

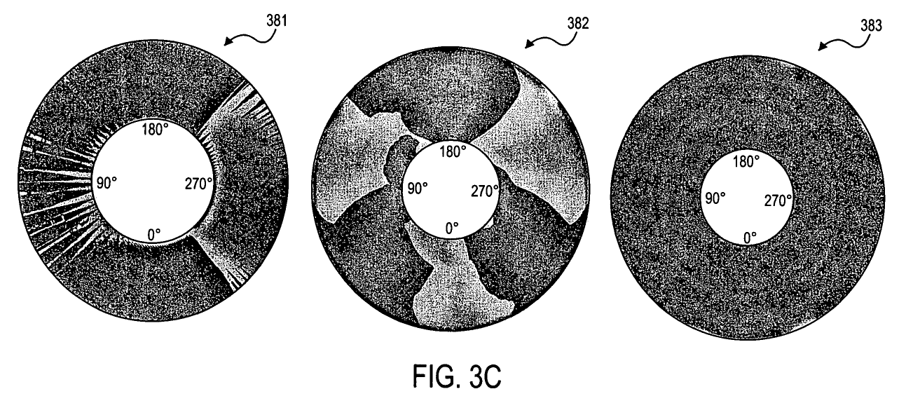

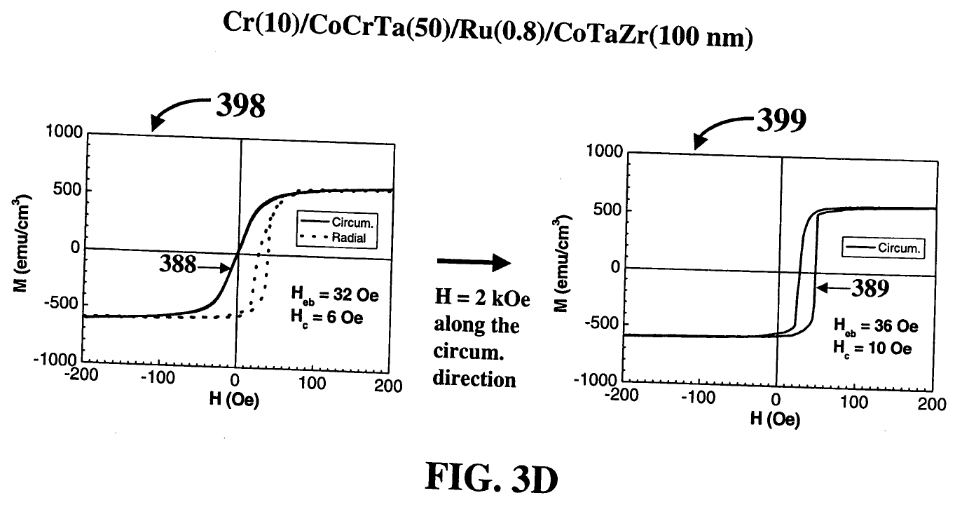

FIG. 3A illustrates the expected full and minor hysteresis loops of the SUL for a perpendicular magnetic recording disk having the structure of a HM pinning layer (of thickness t and coercivity H_{c})/a spacer layer/soft FM pinned film (of thickness t and exchange bias field H_{eb}), according to one embodiment of the present invention. The magnetization versus applied field (M-H) loops illustrated in FIG. 3A show expected results that may be derived by applying a magnetic field along the radial directions of a disk. H_{c} of the HM pinning layer 320 measured in units of Oe that determines the SUL's magnetic stability to stray magnetic fields. H_{eb} in the soft FM pinned film 340 greatly determines the permeability of the SUL. As previously discussed, the SUL with a high permeability enhances the head field strength and gradient during the writing process. SAF coupling between the HM pinning layer 320 and the soft FM layer 340 requires that the interfacial exchange energy (J_{AF}) between these layers should be more than the Zeeman energy (Mᵣ H_{c} t_{FM}) of soft FM pinned layer with a zero external field. Mᵣ is the remanent magnetization measured in units of magnetic moment per unit volume (e.g., emu/cm³). t_{FM} is the thickness of the soft FM layer. In given materials and J_{AF}, lowering H_{c} can increase t_{FM} if the Zeeman energy is constant. As such, it is contemplated that in order to further improve the structure of the soft FM pinned layer 340 with the HM pinning layer 320, either J_{AF} may be increased and/or H_{c} of the soft FM pinned layer may be reduced through selection of layer materials and/or insertion of additional layers in the SUL structure, as discussed below.

FIG. 3B illustrates the measured M-H loops of the SUL for a perpendicular magnetic recording disk with particular layer materials and thickness according to one embodiment of the present invention. A soft FM pinned film 340 with, for example, high 4πMₛ of >5 kG may be selected to avoid saturation effect of the SUL. In one particular embodiment, amorphous Co₉₀Ta₅Zr₅ (=CoTaZr) with H_{c}<1 Oe along the easy axis and 4πMₛ˜13 kG may be used as the material for soft FM pinned film 340, and Co₈₀Cr₁₆Ta₄ (=CoCrTa) with isotropic H_{c}=515 Oe and squareness ratio=0.85 may be used as the material for the HM pinning layer 320. The CoTaZr soft FM pinned film 340 may have a thickness 341, for example, of approximately 100 nm, and the HM pinning layer 320 may have a thickness less than the soft FM pinned film 340. Alternatively, soft FM pinned film 340 may have other thickness, for example, greater than approximately 8 nm.

A perpendicular magnetic recording disk having the following layer materials and thickness was produced: Cr(10) seed layer 315/CoCrTa(50) pinning layer 320/Ru(0.8) spacer layer 330/CoTaZr(100) pinned layer 340, with the numbers in parenthesis indicating respective layer thickness in nm. The magnetization curves were obtained by applying a magnetic field along the radial and circumferential directions of the perpendicular magnetic recording disk. The y-axis provides magnetization M in units of emu/cm³ and the x-axis provides applied field H in units of Oe. As shown in FIG. 3B, with the above noted layer structure, a SAF exchange coupling in a 100 nm-thick CoTaZr layer was achieved. The H_{c} of the CoCrTa HM pinning layer was 595 Oe as noted on FIG. 3B. This enhanced H_{c} from 515 to 595 Oe is due to SAF exchange coupling and magnetostatic interactions between the CoCrTa layer and the CoTaZr layer.

FIG. 3C illustrates the magnetic domain structure characterized by Kerr images, created by an Optical Surface Analyzer (OSA), of different types of SULs on perpendicular magnetic recording disks. A disk 381 processed with a conventional 180 nm-thick CoTaZr single layer with a low H_{c} of <1 Oe shows many 180° domains and reversed edge domains. Asymmetric distribution of magnetic domains may be caused by the existence of in-plane stray fields of 1-2 Oe inside OSA equipment greater than the H_{c} of CoTaZr, as discussed in Wen Jiang et al., Recording Performance Characteristics of Granular Perpendicular Media, IEEE Transactions on Magnetics, In press, January 2005. A disk 382 processed with a SAF coupled SUL with a structure of CoTaZr(90)/Ru(0.8)/CoTaZr(90 nm) exhibits much less magnetic domains with irregular domain shape compared to disk 381 with a conventional single layer SUL. However, virtually no magnetic domains are observed on a disk,383 with a HM-biased SAF coupled SUL with a structure of Cr(10)/CoCrTa(50)/Ru(0.8)/CoTaZr(100 nm).

FIG. 3D illustrates minor M-H loops for the soft FM pinned layer of the disk of FIG. 3B and shows the pinned direction being switched by an external magnetic field. The magnetization curves of chart 398 were obtained by applying a magnetic field along the radial and circumferential directions of the perpendicular magnetic recording disk. The y-axis provides magnetization M in units of emu/cm³ and the x-axis provides applied field H in units of Oe. The minor loop with H_{eb}=32 Oe and H_{c}=6 Oe is similar to the loops of IrMn/(CoTaZr or CoZrNb) but shows both significantly high value of J_{AF}˜0.3 erg/cm² compared to the values of J_{AF}=0.08-0.1 erg/cm² in IrMn/(CoTaZr or CoZrNb) and J_{AF}=0.07-0.09 erg/cm² in CoTaZr/Ru/CoTaZr and better thermal stability based on the Curie temperature of the CoCrTa higher than the Néel temperature of IrMn. An external magnetic field of approximately 2 kOe (being greater than H_{c}=595 Oe of the HM pinning layer 320) was applied along the circumferential direction of the disk. The minor loop 388 along the circumferential direction of the disk was changed from the reversible loop in chart 398 to the hysteretic loop 389 with single remanent magnetization (H_{eb}=36 Oe and H_{c}=10 Oe) in chart 399. As shown in chart 399 of FIG. 3D, when a magnetic field that is greater than the H_{c} of the HM pinning layer 320 is applied in any direction to disk 300, it can induce radial anisotropy along the applied field direction. The induced single remanent magnetization will be maintained under the external stray fields less than H_{c} of the HM pinning layer 320.

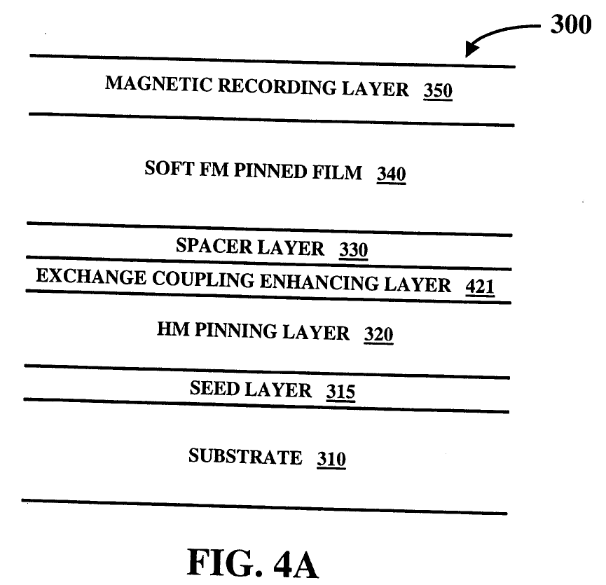

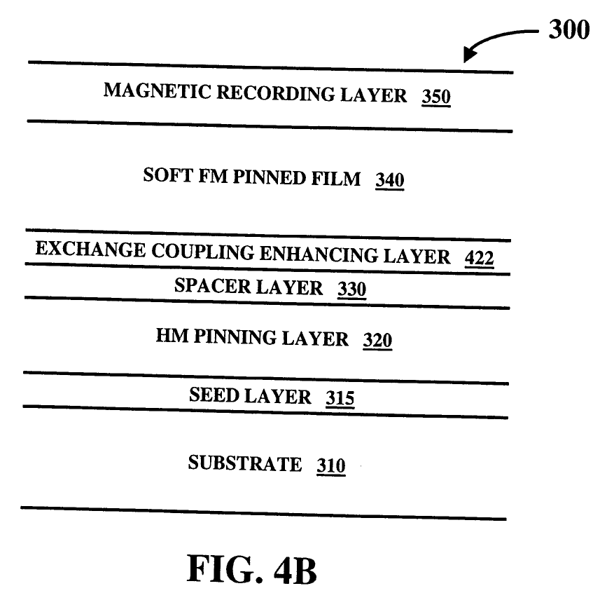

FIG. 4A illustrates an alternative embodiment of a perpendicular magnetic recording disk having an exchange coupling enhancing layer and a HM pinning layer. In this embodiment, to improve single domain stability of the SUL, a thin exchange coupling enhancing layer 421 (e.g., composed of CoFe) is inserted between the HM pinning layer 320 (e.g., composed of CoCrTa) and spacer layer 330 in order to increase J_{AF}. In one embodiment, the thickness for the soft FM pinning layer 421 may be approximately in the range of 1-5 nm. Alternatively, other Co based alloys such as Co, CoSm, CoPt based alloy, CoNi based alloy, and CoCr based alloy may be used for the exchange coupling enhancing layer 421.

As previously discussed, it is also advantageous to decrease the H_{c} of the soft FM pinned film 340. The H_{c} of the soft FM pinned film 340 is decided by contributions of soft FM layer itself and enhancement of H_{c} by exchange coupling with the HM pinning layer. Poor magnetic orientation and more grain isolations of the HM pinning layer can increase the H_{c} of the soft FM pinned film. The H_{c} of the soft FM pinned film 340 may also be lowered by improving the magnetic uniformity of the HM pinning layer 320 through the use of the thin exchange coupling enhancing layer 421 deposited directly above the HM pinning layer 320 and optimization of the Co based alloy through the selection of a proper seed layer and high Co content selected for use as the pinning layers. The H_{c} of the soft FM pinned film 340 may also be lowered by selection of very soft FM materials (e.g., approximately less than 2 Oe) for the soft FM pinned film 340.

FIG. 4B illustrates an alternative embodiment of a perpendicular magnetic recording disk having an exchange coupling enhancing layer and a HM pinning layer. In this embodiment, to improve performance of the SUL, an exchange coupling enhancing layer 422 (e.g., composed of CoFe) is inserted between the spacer layer 330 and the soft FM pinned film 340 in order to increase J_{AF}. In one embodiment, the exchange coupling enhancing layer 422 may have a thickness, for example, in approximately a range of 1-5 nm. Alternatively, other materials similar to those discussed above with respect to the exchange coupling enhancing layer 421 may be used for the exchange coupling enhancing layer 422. In an alternative embodiment, disk 300 may include both exchange coupling enhancing layer 421 and exchange coupling enhancing layer 422.

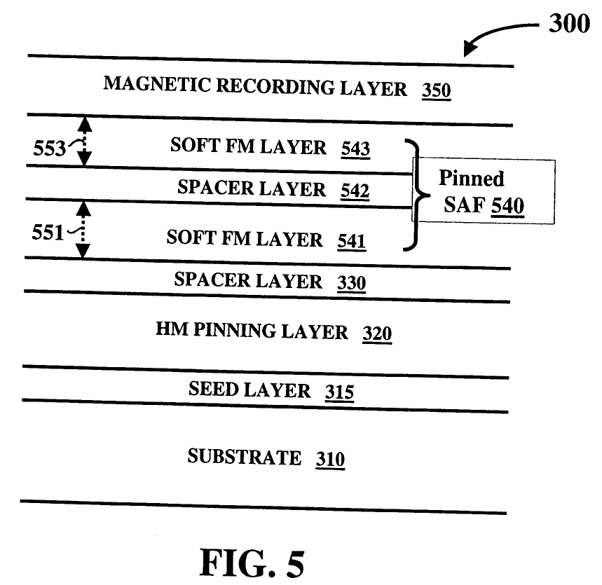

FIG. 5 illustrates one embodiment of a perpendicular magnetic recording disk having a pinned SAF structure. The structure illustrated in FIG. 5 provides an alternate, or supplemental, means that may be used to increase J_{AF} between soft FM film 340 and HM pinning layer 320 in order to improve the performance of the SUL. In this embodiment, a SAF FM/Al/FM multiple layer structure may be used for the soft FM pinned film 340. In particular, the pinned SAF 540 may include a soft FM layer 541, a spacer layer 542 disposed above the soft FM layer 541, and another soft FM layer 543 disposed above the spacer layer 542.

The SAF structure for layers 541 and 543 may also be selected to increase H_{eb} of the soft FM pinned film 340. A thick soft FM pinned layer has a relatively low H_{eb} resulting in a high permeability. Introduction of SAF structure reduces the thickness of the soft FM pinned layers 541 and 543 to get higher H_{eb} while keeping constant total thickness. In one embodiment, the thickness 553 of the soft FM layer 543 may be selected to be less than the thickness 551 of soft FM layer 541. The soft FM pinned layer 543 with a higher H_{eb} has a lower permeability than the soft FM pinned layers 541, effective to reduce adjacent track erasure. Alternatively, other thickness relationships (e.g., approximately equal) may be used for the soft FM layers 541 and 543.

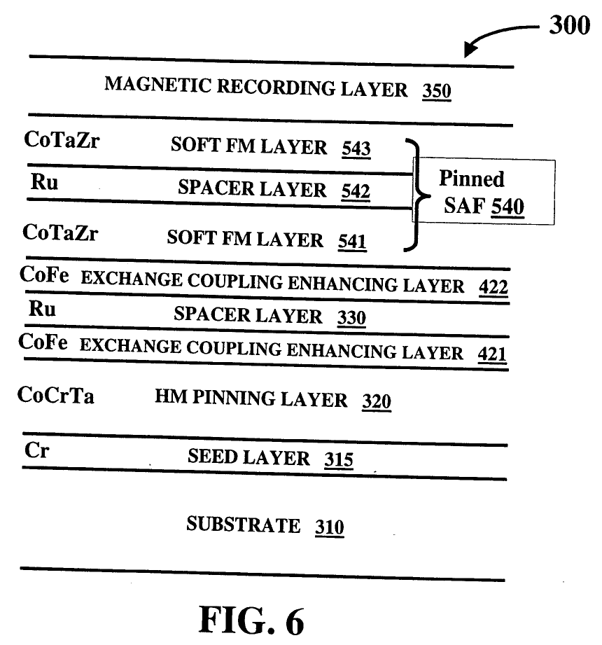

FIG. 6 illustrates an embodiment of a perpendicular magnetic recording disk having a SAF pinned structured and a HM pinning layer with exemplary materials that may be used for each layer. In this embodiment, disk 300 includes a Cr seed layer 315 disposed above substrate 310. A CoCrTa HM pinning layer 320 is disposed above the seed layer 315. A CoFe exchange coupling enhancing layer 421 is disposed above the HM pinning layer 320. A Ru spacer layer 330 is disposed above CoFe exchange coupling enhancing layer 421. A CoFe exchange coupling enhancing layer 422 is disposed above the spacer layer 330. A CoTaZr soft FM layer 541 is disposed above the exchange coupling enhancing layer 422. A Ru spacer layer 542 is disposed above the CoTaZr soft FM layer 541. A CoTaZr soft FM layer 543 is disposed above the spacer layer 542. A magnetic recording layer 350 is disposed above the soft FM layer 543.

In regards to FIGS. 2-6, it should be noted that one or more additional layers may also be disposed between soft FM pinned film 340 and magnetic recording layer 350, for example, a nucleation layer (not shown). Nucleation layer may be used to facilitate a certain crystallographic growth within the magnetic recording layer 350. A structured nucleation layer in addition to the underlayer(s) may provide for a finer crystalline structure and a c-axis preferred orientation of the magnetic recording layer 350. The structured nucleation layer may include multiple intermediate layers providing, for example, for epitaxial growth of subsequently deposited magnetic recording layer 350. A nucleation layer, whether implemented as a nucleating underlayer or an intermediate layer, controls the morphology and grain orientation of subsequent layers. Specifically, a nucleation layer controls grain size, grain spacing, grain orientation and c-axis of the grains of subsequently deposited layers and the magnetic recording layer 350. The nucleation layer material may be selected based on its crystal structure and relatively close lattice match for certain lattice planes to the selected magnetic layer material. To function best as a perpendicular recording layer, the material of the magnetic recording layer 350 (e.g., Cobalt alloy or Cobalt alloy oxide) should have the c-axis of the granular structures disposed perpendicular to the substrate plane. As such, nucleation layer may be used to facilitate a crystal direction in magnetic recording layer 350 that is perpendicular to the film plane. Nucleation layers are known in the art; accordingly, a detailed discussion is not provided. Additional layers, for other examples, may also include other intermediate layer(s) between magnetic recording layer 350 and the soft FM pinned film 340.

Disk 300 may also include one or more layers (not shown) on top of the magnetic recording layer 350. For example, a protection layer may be deposited on top of the magnetic recording layer 350 to provide sufficient properties to meet tribological requirements such as contact-start-stop (CSS) and corrosion protection. Predominant materials for the protection layer are carbon-based materials, such as hydrogenated or nitrogenated carbon. A lubricant may be placed (e.g., by dip coating, spin coating, etc.) on top of the protection layer to further improve tribological performance, for example, a perfluoropolyether or phosphazene lubricant. Protection and lubrication layers are known in the art; accordingly, a detailed discussion is not provided.

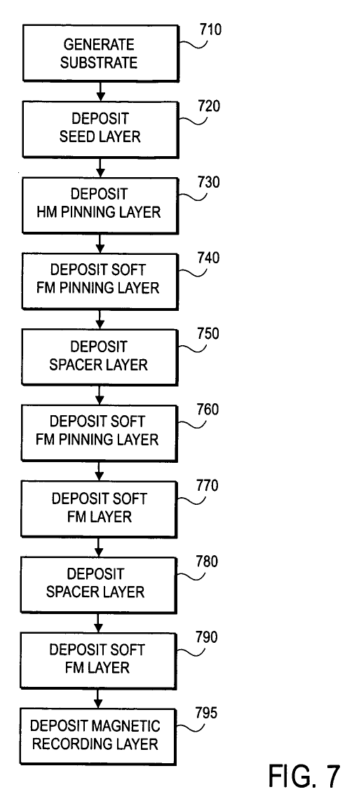

FIG. 7 illustrates one embodiment of a method of manufacturing perpendicular magnetic recording disk 300. A substrate 310 is generated, or otherwise provided, in step 710. The generation of a substrate for a magnetic recording disk is known in the art; accordingly a detailed discussion is not provided. In one embodiment, the substrate 310 may be plated (e.g., with NiP) and may also be polished and/or textured prior to subsequent deposition of layers.

In step 720, the seed layer 315 is deposited above substrate 310. In step 730, the HM pinning layer 320 is deposited above the seed layer 315. In step 740, the exchange coupling enhancing layer 421 is deposited above the HM pinning layer 320. In step 750, a spacer layer 330 is deposited above the exchange coupling enhancing layer 421. In step 760, the exchange coupling enhancing layer 422 is deposited above the spacer layer 330. In step 770, the soft FM layer 541 is deposited above the exchange coupling enhancing layer 422. In step 780, the spacer layer 542 is deposited above the soft FM layer 541. In step 790, the soft FM layer 543 is deposited above the spacer layer 542. In step 795, the magnetic recording layer 350 is deposited above the soft FM layer 543. Additional layers may be deposited below and above the magnetic recording layer 350 as discussed above. It should be noted that one or more of the above steps may be omitted as desired.

The deposition of each of the seed layer, HM pinning layer, spacer layer(s), the soft FM layer(s), the nucleation layer, the magnetic recording layer, and the protection layer can be accomplished by a variety of methods well known in the art, for example, sputtering (e.g., static or in-line), chemical vapor deposition (CVD), ion-beam deposition (IBD), etc. Static sputter systems are available from manufacturers such as Intevac Inc. of Santa Clara, Calif., and Balzers Process Systems, Inc. of Alzenau, Germany. With in-line sputtering systems, disk substrates are loaded on a pallet that pass through a series of deposition chambers the deposit films successively on substrates. In-line sputtering systems are available from manufacturers such as Ulvac Corp. of Japan.

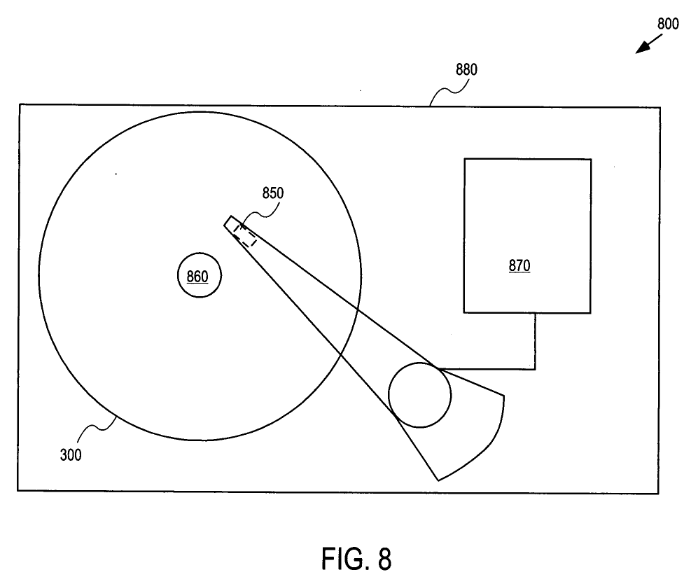

FIG. 8 illustrates a disk drive having disk 300. Disk drive 800 may include one or more disks 300 to store datum. Disk 300 resides on a spindle assembly 860 that is mounted to drive housing 880. Data may be stored along tracks in the magnetic recording layer 350 of disk 300. The reading and writing of data is accomplished with head 850 that has both read and write elements. The write element is used to alter the properties of the perpendicular magnetic recording layer 350 of disk 300. In one embodiment, head 850 may have a magneto-resistive (MR) and, in particular, a giant magneto-resistive (GMR) read element and an inductive write element. In an alternative embodiment, head 850 may be another type of head, for example, an inductive read/write head or a Hall effect head. A spindle motor (not shown) rotates spindle assembly 860 and, thereby, disk 300 to position head 850 at a particular location along a desired disk track. The position of head 850 relative to disk 300 may be controlled by position control circuitry 870. The use of disk 300 fabricated in the manners discussed above may render the perpendicular magnetic recording layer 350 of disk 300 less prone to noise from the soft magnetic underlayer(s).

In the foregoing specification, the present invention has been described with reference to specific exemplary embodiments thereof. It will, however, be evident that various modifications and changes may be made thereto without departing from the broader spirit and scope of the invention as set for in the appended claims. The specification and drawings are, accordingly, to be regarded in an illustrative rather than a restrictive sense.

What is claimed is:

1. A perpendicular magnetic recording disk, comprising:
a substrate;
a hard magnetic pinning layer disposed above the substrate;
a first spacer layer disposed above the hard magnetic pinning layer;
a soft ferromagnetic film disposed above the spacer layer; and
a magnetic recording layer disposed above the soft ferromagnetic film.

2. The perpendicular magnetic recording disk of claim 1, wherein the soft ferromagnetic film has a thickness being greater than approximately 8 nanometers.

3. The perpendicular magnetic recording disk of claim 1, wherein the soft ferromagnetic film has a thickness approximately in a range of 40 to 200 nanometers.

4. The perpendicular magnetic recording disk of claim 1, wherein the hard magnetic pinning layer comprises a material having coercivity in approximately a range of 50 to 2000 Oe.

5. The perpendicular magnetic recording disk of claim 4, wherein the hard magnetic pinning layer comprises an alloy material including cobalt.

6. The perpendicular magnetic recording disk of claim 5, wherein the soft ferromagnetic film comprises a material having coercivity less than approximately 30 Oe along a pinned direction.

7. The perpendicular magnetic recording disk of claim 6, wherein the soft ferromagnetic film comprises CoTaZr.

8. The perpendicular magnetic recording disk of claim 7, wherein the hard magnetic pinning layer comprises CoCrTa.

9. The perpendicular magnetic recording disk of claim 3, wherein the hard magnetic pinning layer has a thickness less than or equal to that of the soft ferromagnetic film thickness.

10. The perpendicular magnetic recording disk of claim 1, wherein the first spacer layer provides an antiferromagnetic exchange bias field between the hard magnetic layer and the soft ferromagnetic film.

11. The perpendicular magnetic recording disk of claim 1, further comprising a first exchange coupling enhancing layer disposed between the hard magnetic pinning layer and the spacer layer.

12. The perpendicular magnetic recording disk of claim 1, wherein the first exchange coupling enhancing layer comprises an alloy material including Co.

13. The perpendicular magnetic recording disk of claim 12, wherein the alloy material of the first exchange coupling enhancing layer comprises CoFe.

14. The perpendicular magnetic recording disk of claim 11, further comprising a second exchange coupling enhancing layer disposed between the spacer layer and the soft ferromagnetic film, wherein the second exchange coupling enhancing layer comprises CoFe.

15. The perpendicular magnetic recording disk of claim 1, wherein the soft ferromagnetic film comprises a synthetic antiferromagnetic multiple layer structure.

16. The perpendicular magnetic recording disk of claim 1, wherein the soft ferromagnetic film comprises:
a first soft ferromagnetic layer disposed above the spacer layer;
a second spacer layer disposed above the first soft ferromagnetic layer; and
a second soft ferromagnetic layer disposed above the second spacer layer.

17. The perpendicular magnetic recording disk of claim 16, further comprising a first exchange coupling enhancing layer disposed between the hard magnetic pinning layer and the spacer layer.

18. The perpendicular magnetic recording disk of claim 17, further comprising a second exchange coupling enhancing layer disposed between the spacer layer and the soft ferromagnetic film.

19. The perpendicular magnetic recording disk of claim 13, wherein each of the first and second exchange coupling enhancing layers comprises an alloy material including Co.

20. The perpendicular magnetic recording disk of claim 16, wherein the second soft ferromagnetic layer has a thickness less than or equal to that of the first soft ferromagnetic layer.

21. The perpendicular magnetic recording disk of claim 19, wherein each of the first and second soft ferromagnetic layers comprises CoTaZr.

22. The perpendicular magnetic recording disk of claim 1, wherein the hard magnetic pinning layer has a thickness approximately in a range of 5 to 100 nanometers and less than a thickness of the soft ferromagnetic film.

23. The perpendicular magnetic recording disk of claim 1, wherein J_{AF} is an interfacial exchange energy between the hard magnetic pinning layer and the soft ferromagnetic film, H, is a coercivity of the soft ferromagnetic film, Mᵣ is a remanent magnetization of the soft ferromagnetic film, and t_{FM} is a thickness of the soft ferromagnetic film, and wherein J_{AF}>H_{c} Mᵣ t_{FM}.

24. The perpendicular magnetic recording disk of claim 1, wherein the soft ferromagnetic film has coercivity approximately less than 30 Oe along a pinned direction.

25. The perpendicular magnetic recording disk of claim 1, further comprising:
means for increasing interfacial exchange energy between the hard magnetic pinning layer and the soft ferromagnetic film.

26. The perpendicular magnetic recording disk of claim 25, further comprising means for controlling magnetic stability of the perpendicular recording disk from stray fields.

27. The perpendicular magnetic recording disk of claim 25, further comprising means for decreasing coercivity of the soft ferromagnetic film.

28. The perpendicular magnetic recording disk of claim 4, wherein the hard magnetic pinning layer comprises a hard magnetic material.

29. The perpendicular magnetic recording disk of claim 4, wherein the hard magnetic pinning layer comprises a hard magnetic material coupled with a soft ferromagnetic material.

30. A disk drive, comprising:
a head having a magneto-resistive read element; and
a perpendicular magnetic recording disk operatively coupled to the head, wherein the perpendicular magnetic recording disk comprises:
a substrate;
a hard magnetic pinning layer disposed above the substrate;
a first spacer layer disposed above the hard magnetic pinning layer;
a soft ferromagnetic film disposed above the spacer layer; and
a magnetic recording layer disposed above the soft ferromagnetic film

31. The disk drive of claim 30, wherein the soft ferromagnetic film has a thickness approximately in a range of 40 to 200 nanometers.

32. The disk drive of claim 30, wherein the hard magnetic pinning layer comprises a material having coercivity in a range of approximately 100 to 2000 Oe.

33. The disk drive of claim 32, wherein the hard magnetic pinning layer comprises an alloy material including cobalt.

34. The disk drive of claim 33, wherein the hard magnetic pinning layer comprises CoCrTa, and wherein the soft ferromagnetic film comprises CoTaZr.

35. The disk drive of claim 30, wherein the hard magnetic pinning layer has a thickness less than or equal to that of a soft ferromagnetic film thickness.

36. The disk drive of claim 30, wherein the perpendicular magnetic recording disk further comprises a first exchange coupling enhancing layer disposed between the hard magnetic pinning layer and the spacer layer.

37. The disk drive of claim 36, wherein the alloy material of the first exchange coupling enhancing layer comprises CoFe.

38. The disk drive of claim 37, wherein the perpendicular magnetic recording disk further comprises a second exchange coupling enhancing layer disposed between the spacer layer and the soft ferromagnetic film, wherein the second exchange coupling enhancing layer comprises CoFe.

39. The disk drive of claim 30, wherein the soft ferromagnetic film comprises:
a first soft ferromagnetic layer disposed above the spacer layer;
a second spacer layer disposed above the first soft ferromagnetic layer; and
a second soft ferromagnetic layer disposed above the second spacer layer.

40. The disk drive of claim 39, wherein the perpendicular magnetic recording disk further comprises a first exchange coupling enhancing layer disposed between the hard magnetic pinning layer and the spacer layer.

41. The disk drive of claim 40, wherein the perpendicular magnetic recording disk further comprises a second exchange coupling enhancing layer disposed between the spacer layer and the soft ferromagnetic film.

42. The disk drive of claim 40, wherein J_{AF} is an interfacial exchange energy between the hard magnetic pinning layer and the soft ferromagnetic film, H_{c} is a coercivity of the soft ferromagnetic film, Mᵣ is a remanent magnetization of the soft ferromagnetic film, and t_{FM} is a thickness of the soft ferromagnetic film, and wherein J_{AF}>H_{c} Mᵣ t_{FM}.

43. A method, comprising:
depositing a hard magnetic pinning layer above a substrate;
depositing a first spacer layer above the hard magnetic pinning layer;
depositing a soft ferromagnetic film having a thickness greater than approximately 8 nanometers above the spacer layer; and
depositing a magnetic recording layer above the soft ferromagnetic film.

44. The method of claim 43, wherein the soft ferromagnetic film is deposited to have the thickness approximately in a range of 40 to 200 nanometers.

45. The method of claim 43, further comprising depositing an exchange coupling enhancing layer above the hard magnetic pinning layer, wherein the exchange coupling enhancing layer is disposed below the first spacer layer.

46. The method of claim 45, wherein the exchange coupling enhancing layer is composed of an alloy material comprising Co.

47. The method of claim 43, further comprising depositing an exchange coupling enhancing layer above the first spacer layer, wherein the first exchange coupling enhancing layer is disposed below the soft ferromagnetic film.

48. The method of claim 47, wherein the exchange coupling enhancing layer is composed of an alloy material comprising Co.

49. The method of claim 43, wherein depositing the soft ferromagnetic film comprises:
depositing a first soft ferromagnetic layer;
depositing a second spacer layer above the first soft ferromagnetic layer; and
depositing a second soft ferromagnetic layer above the second spacer layer.

50. The method of claim 49, further comprising:
depositing a first exchange coupling enhancing layer above the hard magnetic pinning layer, wherein the first exchange coupling enhancing layer is disposed below the first spacer layer; and
depositing a second exchange coupling enhancing layer above the first spacer layer, wherein the second exchange coupling enhancing layer is disposed below the soft ferromagnetic film.
